(19) United States
(12) Patent Application Publication
(10) Pub. No.: US 2015/0220523 A1
(43) Pub. Date: Aug. 6, 2015

(54) Customizable Workout Video System

(71) Applicant: SPX Fitness, Inc., Burbank, CA (US)

(72) Inventor: Sebastien Anthony Louis Lagree, West Hollywood, CA (US)

(73) Assignee: SPX Fitness, Inc.

(21) Appl. No.: 14/613,720

(22) Filed: Feb. 4, 2015

Related U.S. Application Data
(60) Provisional application No. 61/935,425, filed on Feb. 4, 2014.

(51) Int. Cl. G06F 17/30

(52) U.S. Cl. CPC G06F 17/30017; G06F 17/30864

(57) ABSTRACT

A computer-implemented method for creating a multimedia exercise routine. In the computer-implemented method, a plurality of exercise multimedia files are accessed, wherein each of the plurality of exercise multimedia files comprise metadata. A plurality of exercise multimedia files are sorted based on the metadata. A sequence of the plurality of exercise multimedia files are selected, and a multimedia exercise routine comprising the sequence of plurality of exercise multimedia files is created.

### CROSS REFERENCE TO RELATED APPLICATIONS

I hereby claim benefit under Title 35, United States Code, Section 119(e) of U.S. provisional patent application Ser. No. 61/935,425 filed Feb. 4, 2014. The 61/935,425 application is currently pending. The 61/935,425 application is hereby incorporated by reference into this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to a customizable multimedia physical workout routine and more specifically it relates to a customizable multimedia Pilates workout video system/method that enables a user (e.g., instructor or exerciser) to create/modify a Pilates exercise routine comprising a sequence of Pilates exercises.

2. Description of the Related Art

Any discussion of the related art throughout the specification should in no way be considered as an admission that such related art is widely known or forms part of common general knowledge in the field.

Conventional Pilates apparatuses are well known in the fitness industry worldwide, and are generally comprised of a rectangular and horizontal base structure with parallel rails aligned with the major axis of the rectangular structure, and a sliding carriage thereupon that is attached to one end of the structure by springs or elastic bands that produce a resistance bias. Sliding the carriage away from the end of the apparatus to which the spring resistance means are attached creates a workload against which therapeutic or fitness exercises can be safely and beneficially performed.

With nearly 10 million participants in the United States, Pilates is one of the most popular fitness training methods to improve cardiovascular efficiency, flexibility, balance and muscle strength. Depending on the experience of the exerciser, fitness routines can span the range from gentle, short duration workouts, to long duration, high intensity routines of many complex exercises performed against high spring resistance with little or no rest in between each exercise.

Many exercises performed on a Pilates apparatus are typically repeated a number of times before changing the apparatus setup, and/or changing to the next exercise in the sequence. Oftentimes, at least five to ten repetitions are performed for each exercise.

A routine consists of a series of exercises (or sequence of exercises). For example, a one-hour, high intensity routine may consist of 10 separate exercises, each one being performed for four to five minutes, followed by a short cool-down period.

In order to maximize the benefit of the hour-long workout, it is advantageous to limit the time period between the sequences of exercises in the exercise routine. It should be further noted that there are hundreds, perhaps even thousands of exercises and variations of exercises that may be performed. To further complicate the creation of an appropriate and beneficial exercise routine, instructors and exercisers must select from the large collection of exercises those which are intended to exercise or stretch certain muscles. For instance, certain exercises will necessarily concentrate on lower body muscles such as calves, inner or outer thighs, buttocks, lower or upper back, abdominal muscles, upper torso or chest, arms, shoulders or neck muscles.

In order to realize the benefits of a whole body workout, it is important to incorporate a collection of exercises into a single routine that addresses all of the muscles that will be targeted during any given routine.

As is well known to those skilled in the art, even when performing a routine that targets every primary muscle group during the routine, it is desirable that exercises are first selected that address the major muscles, such as legs, followed by exercises that target ever decreasing muscle groups based on their ability to perform work. Properly trained and certified fitness instructions understand that this is an important muscle training sequence that helps prevent injury to the smaller muscles, joints or connective tissue.

It should be appreciated that Pilates instructors that strive to deliver increasingly challenging routines to their client exercisers face a considerably complex task of selecting, instructing in the performance of, and ensuring exerciser safety throughout a routine of Pilates exercises that comprise a routine.

Typically, when creating a workout routine, a Pilates instructor maintains a manual in which exercises and the sequence of exercises are written down for each exercising client, and referred to before and during the exercise routine. This common practice falls short of achieving safety, duration and intensity objectives previously described, especially when instructing a class of many Pilates exercisers, each of whom has different objectives, fitness levels, muscle strengths, or injury considerations.

Further, another problem with the current practice of instructing Pilates classes is the loss of exercise time as members of the exercising class change positions and spring resistance between the performance of one exercise and the next exercise in the routine sequence. For instance, if the class required 60 seconds between each of ten exercises in order to change positions on the apparatus, change resistance, and reference the proper method of performing the next exercise in the routine, then ten minutes of exercising time would be lost throughout the routine.

From a therapeutic perspective, exercisers would require an additional ten minutes to realize the full benefit of the routine. However, when the next class is schedules for the following hour, the exercisers would be required to vacate their apparatuses in order for the next class of exercisers to occupy the apparatuses.

Therefore, it can readily be seen that the therapeutic value of a routine can be increased significantly if Pilates instructors implemented a more precise methodology of delivering a properly designed and recorded routine to their classes.

Because of the inherent problems with the related art, there is a need for a new and improved system/method of creating, monitoring, recording and delivering specialized Pilates exercise routines, and the benefits related to instructors' ability to deliver high intensity routines to classes in a shorter amount of time. Full body workouts in shorter duration routines equates to an increase in the number of classes that can be instructed during a normal workday. There is significant commercial value in a system and method of ensuring minimum down-time between exercises in a routine, and maximizing the workout intensity for each of the targeted muscle groups during the routine.

### BRIEF SUMMARY OF THE INVENTION

The invention generally relates to a method of creating/modifying a multimedia exercise routine comprising a sequence of a plurality of exercise multimedia files.

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto. In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a system for creating/modifying a multimedia exercise routine of the present invention.

FIG. 2 is a flow chart of a method of creating a multimedia exercise routine of the present invention.

FIG. 3 is a flow chart of a method of creating a multimedia exercise routine of the present invention.

FIG. 4 is a flow chart of a method of creating a multimedia exercise routine of the present invention.

FIG. 5 is a table that includes a list of individually identifiable Pilates exercises in a database of the present invention.

FIG. 6 is a chart of a Pilates exercise routine comprising a sequence of two or more exercises.

FIG. 7 is an exemplary interface and home page for the application on a mobile device providing the user with options to select from to start an exercise routine.

FIG. 8 is an exemplary interface displayed after selecting “Preset Routines” from FIG. 7 to present different exercise machine options to the user to select from.

FIG. 9 is an exemplary interface displaying the various Preset Routines the user may select from and play based on the machine selection in FIG. 8.

FIG. 10 is an exemplary interface providing time duration options for the user to select from so the user controls the length of time for each exercise performed in the routine.

FIG. 11 is an exemplary interface illustrating the display of the wheel barrow exercise as part of a Preset Routine which the user can control by pausing, reversing or fast forwarding the exercise animation of an individual on the exercise machine performing the exercise.

FIG. 12 is an exemplary interface displayed on the mobile device when a “Create Routine” option is selected from FIG. 7 displaying the machines the user is able to create an exercise routine for.

FIG. 13 is an exemplary display of the various routines for the selected exercise machine from FIG. 12 that the user can add to their customized exercise routine.

FIG. 14 is an exemplary display of the exercise routines selected for the customized workout routine where the user can remove a routine or move the position played with respect to the other routines.

FIG. 15 is an exemplary display of the selected exercise routines in FIG. 14 with the Cobra routine moved to the top of the list to be played first.

FIG. 16 is an exemplary display providing various time options for each of the exercise routines selected for the customized workout.

FIG. 17 is an exemplary interface where the user enters a customized name for the custom workout routine to be saved and used later.

FIG. 18 is an exemplary interface providing the user with the option to start the customized routine created, create another routine or return to the home page.

FIG. 19 is an exemplary illustration of the first routine (Cobra) of the customized workout routine being played via a graphical animation or video of an actual person performing the Cobra workout.

FIG. 20 is an exemplary illustration of the second routine (Arm Circles) of the customized workout routine being visually played for the user.

FIG. 21 is an exemplary illustration of the third routine (Cat Fish) of the customized workout routine being visually played for the user.

FIG. 22 is an exemplary illustration of the fourth routine (5^{th} Lunge Carriage Kicks, R) of the customized workout routine being visually played for the user.

FIG. 23 is an exemplary illustration of the fifth and last routine (Escalator Lunge, L) of the customized workout routine being visually played for the user.

FIG. 24 is an exemplary interface providing the user with the list of saved routines when the “Saved Routines” button is selected from the home page in FIG. 7.

### DETAILED DESCRIPTION OF THE INVENTION

### A. Overview of Invention

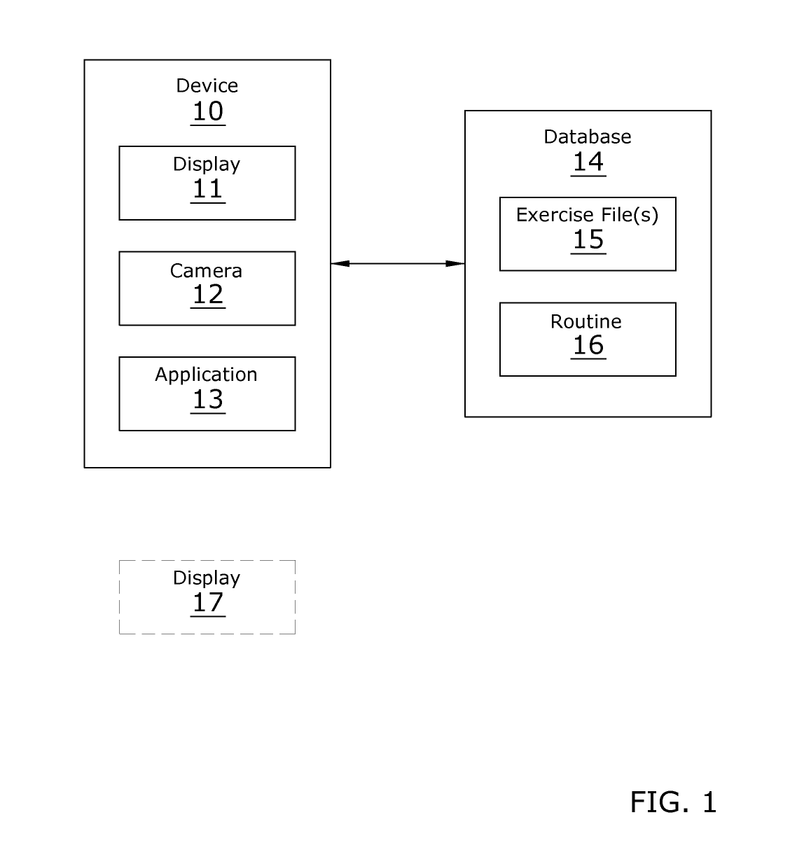

FIGS. 1 through 24 illustrate the present invention. The customizable workout video system (as depicted in FIG. 1) generally includes device 10 comprising application 13, database 14 and display 17.

### B. Exemplary Telecommunications Networks

The present invention may be utilized upon any telecommunications network capable of transmitting data including voice data and other types of electronic data. Examples of suitable telecommunications networks for the present invention include but are not limited to global computer networks (e.g. Internet), wireless networks, cellular networks, satellite communications networks, cable communication networks (via a cable modem), microwave communications networks, local area networks (LAN), wide area networks (WAN), campus area networks (CAN), metropolitan-area networks (MAN), and home area networks (HAN). The present invention may communicate via a single telecommunications network or multiple telecommunications networks concurrently. Various protocols may be utilized by the electronic devices for communications such as but not limited to HTTP, SMTP, FTP and WAP (wireless Application Protocol). The present invention may be implemented upon various wireless networks such as but not limited to 3G, 4G, LTE, CDPD, CDMA, GSM, PDC, PHS, TDMA, FLEX, REFLEX, IDEN, TETRA, DECT, DATATAC, and MOBITEX. The present invention may also be utilized with online services and internet service providers.

The Internet is an exemplary telecommunications network for the present invention. The Internet is comprised of a global computer network having a plurality of computer systems around the world that are in communication with one another. Via the Internet, the computer systems are able to transmit various types of data between one another. The communications between the computer systems may be accomplished via various methods such as but not limited to wireless, Ethernet, cable, direct connection, telephone lines, and satellite.

### C. Central Communication Unit

The central communication unit may be comprised of any central communication site where communications are preferably established with. The central communication units may be comprised of a server computer, cloud based computer, virtual computer, home computer or other computer system capable of receiving and transmitting data via IP networks and the telecommunication networks. As can be appreciated, a modem or other communication device may be required between each of the central communication units and the corresponding telecommunication networks. The central communication unit may be comprised of any electronic system capable of receiving and transmitting information (e.g. voice data, computer data, etc.).

### D. Mobile Device

The mobile device may be comprised of any type of computer for practicing the various aspects of the present invention. For example, the mobile device can be a personal computer (e.g. APPLE® based computer, an IBM based computer, or compatible thereof) or a tablet computer (e.g. IPAD®). The mobile device may also be comprised of various other electronic devices capable of sending and receiving electronic data including but not limited to smartphones, mobile phones, telephones, personal digital assistants (PDAs), mobile electronic devices, handheld wireless devices, two-way radios, smart phones, communicators, video viewing units, television units, television receivers, cable television receivers, pagers, communication devices, and digital satellite receiver units.

The mobile device may comprised of any conventional computer. A conventional computer preferably includes a display screen (or monitor), a printer, a hard disk drive, a network interface, and a keyboard. A conventional computer also includes a microprocessor, a memory bus, random access memory (RAM), read only memory (ROM), a peripheral bus, and a keyboard controller. The microprocessor is a general-purpose digital processor that controls the operation of the computer. The microprocessor can be a single-chip processor or implemented with multiple components. Using instructions retrieved from memory, the microprocessor controls the reception and manipulations of input data and the output and display of data on output devices. The memory bus is utilized by the microprocessor to access the RAM and the ROM. RAM is used by microprocessor as a general storage area and as scratch-pad memory, and can also be used to store input data and processed data. ROM can be used to store instructions or program code followed by microprocessor as well as other data. A peripheral bus is used to access the input, output and storage devices used by the computer. In the described embodiments, these devices include a display screen, a printer device, a hard disk drive, and a network interface. A keyboard controller is used to receive input from the keyboard and send decoded symbols for each pressed key to microprocessor over bus. The keyboard is used by a user to input commands and other instructions to the computer system. Other types of user input devices can also be used in conjunction with the present invention. For example, pointing devices such as a computer mouse, a track ball, a stylus, or a tablet to manipulate a pointer on a screen of the computer system. The display screen is an output device that displays images of data provided by the microprocessor via the peripheral bus or provided by other components in the computer. The printer device when operating as a printer provides an image on a sheet of paper or a similar surface. The hard disk drive can be utilized to store various types of data. The microprocessor, together with an operating system, operate to execute computer code and produce and use data. The computer code and data may reside on RAM, ROM, or hard disk drive. The computer code and data can also reside on a removable program medium and loaded or installed onto a computer system when needed. Removable program mediums include, for example, CD-ROM, PC-CARD, USB drives, floppy disk and magnetic tape. The network interface circuit is utilized to send and receive data over a network connected to other computer systems. An interface card or similar device and appropriate software implemented by microprocessor can be utilized to connect the computer system to an existing network and transfer data according to standard protocols.

### E. Summary of Present Invention

The present invention is a new and novel Pilates exercise routine development and instruction system and method that increases the effectiveness of instructing and performing a collection of exercises during a Pilates exercise routine.

More specifically, the beneficial system and method comprises a multimedia database containing a plurality of individual Pilates exercises, each exercise may include one or more of an exercise identifier, an instructional video demonstrating the proper performance of the exercise, and metadata. The metadata may be specific to each exercise and includes but is not limited to duration, muscle group targeted by the exercise, intensity level, number of repetitions an exerciser should perform the exercise, a method of organizing the sequence of selected exercises into a routine sequence, and a method of delivering the multimedia file via video and audio means to one or more exercisers participating in a Pilates class.

Further, the present invention incorporates a means for an instructor to create one or more routines, that include a series of exercises in advance of instructing a series of Pilates classes, thereby allowing an instructor to assemble a multi-day or multi-week series of routines that safely and beneficially increases the intensity of exercises in subsequent workout classes, while providing a record of targeted muscle groups or each routine in order to prevent overstressing muscles by repeating exercises that target the same muscle groups in sequential routines.

Further, the Pilates exercise routine, training and instruction system and method allows an instructor to make changes to a pre-defined sequence of exercises in a routine. For instance, an instructor may elect to repeat a certain exercise twice, while the routine originally called for the exercise to be performed once. In real time, by means of an electronic controller (e.g., a computing device), an instructor may change the exercise order, number of repetitions, intensity, or duration of one or more exercises, and may even delete and add exercises during playback of the routine.

As previously described, it is important to record the actual exercises performed during a complete routine in order to ensure that certain exercises that could cause injury are not repeated too frequently over multiple days or workout sessions. Therefore the present invention records routines, even when they are changed by the instructor in real time during a routine.

One exemplary embodiment of the present invention is a customizable Pilates workout video system comprising a multimedia database containing a plurality of individual Pilates exercises, each exercise defined with a unique identifier, and associated with one or more metadata fields, the exercises being assemblable in a sequence so as to form a workout routine. The routine can then be saved on the database for recall by a Pilates instructor or an exerciser at a later time during the instruction of a Pilates class.

Another exemplary embodiment of the present invention is a system and method allowing a Pilates instructor or exerciser, in real time, to retrieve and play one or more exercises from a database of Pilates without the requirement for the exercise to be one of the exercises in a pre-programmed sequence of exercises.

Yet another exemplary embodiment of the present invention is a system and method of displaying important information to the exerciser related to each exercise in a routine. The information may include, but is not limited to a pre-recorded video or animation showing the proper body position upon a Pilates apparatus, and the subsequent proper performance of the exercise. The information may also include additional instruction regarding certain settings on the Pilates apparatus for each exercise. For example, setting the incline angle, or attaching a certain number of resistance springs between the apparatus structure and sliding carriage, and the number of repetitions, or duration for which the exercise should be performed.

Another exemplary embodiment of the present invention is a system and method of manually changing the sequence of exercises contained in a pre-programmed sequence of exercises, and saving the edited sequence of exercises as a new routine.

Still another exemplary embodiment of the present invention is a Pilates workout system and method that provides for the delivery of instructional multimedia files to one or more exercisers via one or more display means, either wired or wirelessly networked to a database of Pilates exercises and routines.

Another exemplary embodiment of the present invention is a means of controlling the creation and saving of a routine of exercises, and providing for the starting and ending of a sequence of exercise videos comprising the routine, such means being via wired or wireless connection of a controller to a database of Pilates exercises and pre-programmed routines of exercises.

Yet another exemplary embodiment of the present invention is a system and method of creating a routine of Pilates exercises based in part on creating a definition list of objectives. The objectives may define the metadata fields and retrieving from a database of Pilates exercises only those exercises meeting the metadata requirement, and selecting one of the qualifying exercises for incorporation into a sequence of exercises that comprise a routine.

These and other embodiments will become known to one skilled in the art, especially after understanding the significant commercial advantages of designing, saving, and re-playing Pilates routines that shorten exercise time, increase assurances of safety and prevention of overstressing muscles, more effectively instruct exercisers on the positioning and performance of each exercise in a routine of exercises, and recording of routines for future editing or reuse. The present invention is not intended to be limited to the disclosed embodiments.

### F. Embodiments of System for Creating a Multimedia Exercise Routine

FIG. 1 depicts an embodiment of a system for creating a multimedia exercise routine. The system includes, among other things, device 10 which comprises application 13, and database 14.

Device 10 can be any computing device that is able to facilitate in generating a multimedia exercise routine via application 13. For example, device 10 is a mobile device, table, desktop, server, etc. Device 10 may include display 11 and camera 12, which will be described in further detail below.

In one embodiment, application 13 resides on device 10 and is executed on device 10. In another embodiment, application 13 is located and executed at another location, such as a cloud computing environment.

Application 13, when executed, enables, among other things, the creating of a multimedia exercise routine. In general, application 13 is able to create a multimedia exercise routine (e.g., a Pilates multimedia exercise routine) that includes a plurality of exercise multimedia files (e.g., a plurality of Pilates exercise multimedia files). For example, application 13 creates multimedia exercise routine 16 (also referred herein as “routine” or “exercise routine”) that includes a sequence of exercise files 15.

Application 13 is able to access files in database 14 and enable the files to be displayed. For example, routine 16, which a multimedia file, is able to be displayed on display 11 of device 10 and/or on display 17.

Database 14 is any storage device that is able to store multimedia files such as exercise files 15 and routines (e.g., routine 16). Database 14, in one embodiment, is local storage that is located in device 10. However, database 14 may also be remote from device 10. For example, device 10 is able to wirelessly access remote database 14.

It should be noted that the multimedia file database 14 may be installed on a local server within a small network, a remote server, or a cloud-based server, and the database may be accessed by one or more clients through one or more Large Area Networks (LAN), cellular networks, or other Wireless Local Area Networks (WLAN), via wired or wireless connection as required for each client.

### H. Embodiments of Operations of a System for Creating a Multimedia Exercise Routine

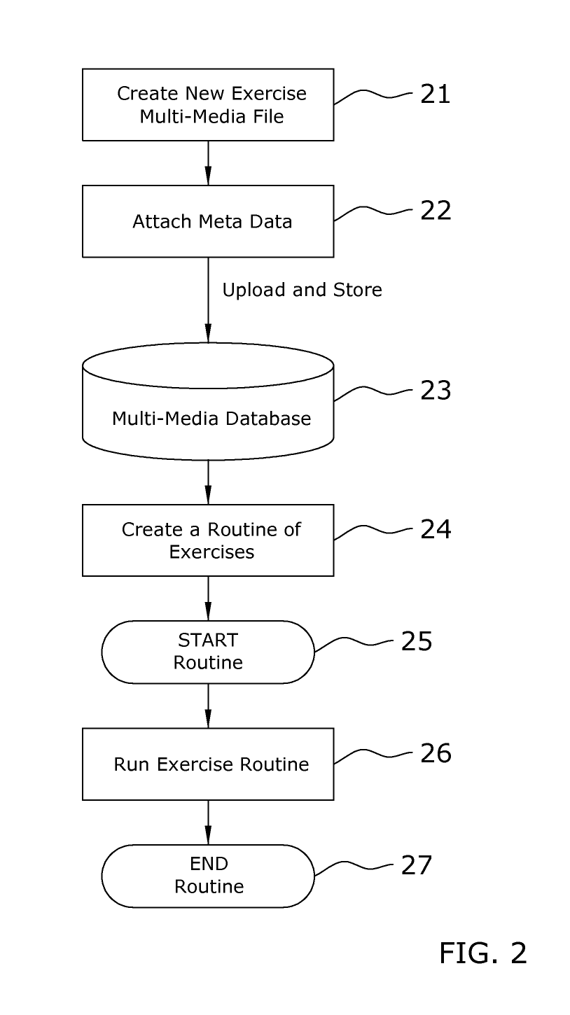

FIG. 2 depicts an embodiment of a flow chart of a method 20 of creating a multimedia exercise routine. More specifically, the flow chart of method 20 depicts the creation and uploading of a multimedia exercise routine.

At 21, an exercise multimedia file (also referenced as “multimedia file”) is created. The exercise multimedia file is one of exercise files 15. Exercise multimedia file is created by filming an exerciser performing a specific exercise. The creation of the exercise multimedia file can be done with the use of a smartphone or video camera, and may or may not include an accompanying audio file. The exercise multimedia file may be filmed via camera 12 of device 10. Additionally, the exercise multimedia file may be generated via application 13.

Further, in various embodiments, the exercise multimedia file may be created using computer animation, preferably the animation properly representing an avatar performing a specific exercise. The multimedia file may be edited in post-production in any number of ways, including the overlay of graphic images or instructions, closed captioning text reflecting audible instructions that may be included, voice-over content, or the multimedia file may be shortened or lengthened as desired by the creators. As can readily be understood, the method of creating a multimedia file is not meant to be limiting, but rather to express the spirit and intention of creating a digital file of a determined length that adequately serves as an instructional guide for a person performing an exercise on a Pilates apparatus.

At 22, following the completion of the production of one or more multimedia files, certain metadata is created and associated with each multimedia file. The metadata is used to correlate the multimedia file with certain attributes. Such attributes may include features and parametric information useful to an exerciser or Pilates exercise instructor when considering various exercises for incorporation into a routine of more than one exercise.

Metadata may include, but is not limited to, name of the exercise, title of the multimedia file, length of the multimedia file expressed in time increments, association of the primary muscle groups that would be targeted by the exercise, the number of repetitions an exercise may perform the exercise, the relative intensity of the exercise when compared to other exercises, recommended resistance settings or other specifics regarding the setup of a Pilates apparatus prior to performing the exercise, or the recommended positioning of an exercise upon a Pilates apparatus prior to performing a specific exercise. FIG. 5 depicts an embodiment of a list of individually identifiable exercise multimedia files in a database, which will be described in further detail below.

At 23, following the attachment of metadata, if desired, the multimedia file is uploaded and stored into a multimedia database, such as database 14. The file may be accessed at a later time by a Pilates instructor or an exerciser.

At 24, a multimedia exercise routine 16 is created. The multimedia exercise routine includes a plurality of exercise multimedia files, wherein the exercises depicted in the multimedia files are performed in sequence upon a Pilates apparatus.

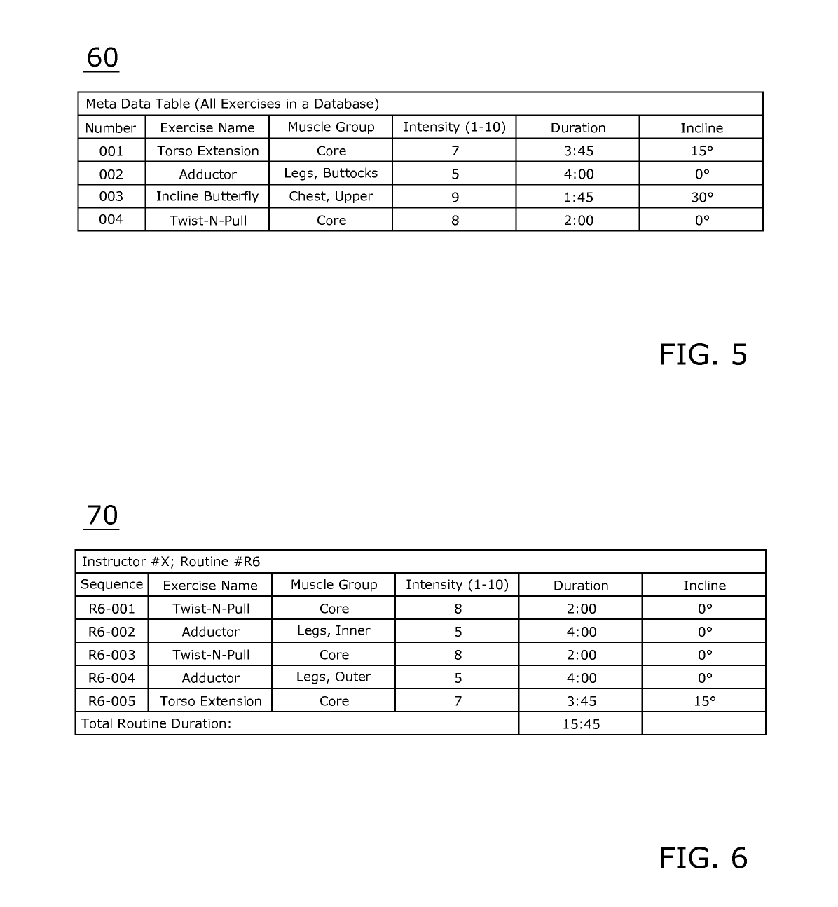

For example, application 13 creates multimedia exercise routine 16 based on user input at device 10. The user can be, but is not limited to, a Pilates instructor or Pilates exerciser. More specifically, the user may access the database of exercise files 15 via application 13, and select one or more exercises to assemble as a multimedia exercise routine 16. FIG. 6 depicts an embodiment of a chart of routine, which will be described in further detail below.

At 25, following the creation of an exercise routine, the exerciser or instructor may start playing routine 16 as an instructional multimedia file displayed by means of a digital display, such as display 17 (e.g., video monitor, video projector, etc.)

At 26, the exercise routine is “run” or displayed. For example, the exercise routine is displayed on a video monitor or video projection, such that one or more exercisers would be able to run and view the instructional video routine during and throughout their exercise session upon a Pilates apparatus.

At 27, the exercise routine is ended. For example, when the routine of exercise multimedia files has completed playback, the exercise routine ends, and the exerciser stops exercising.

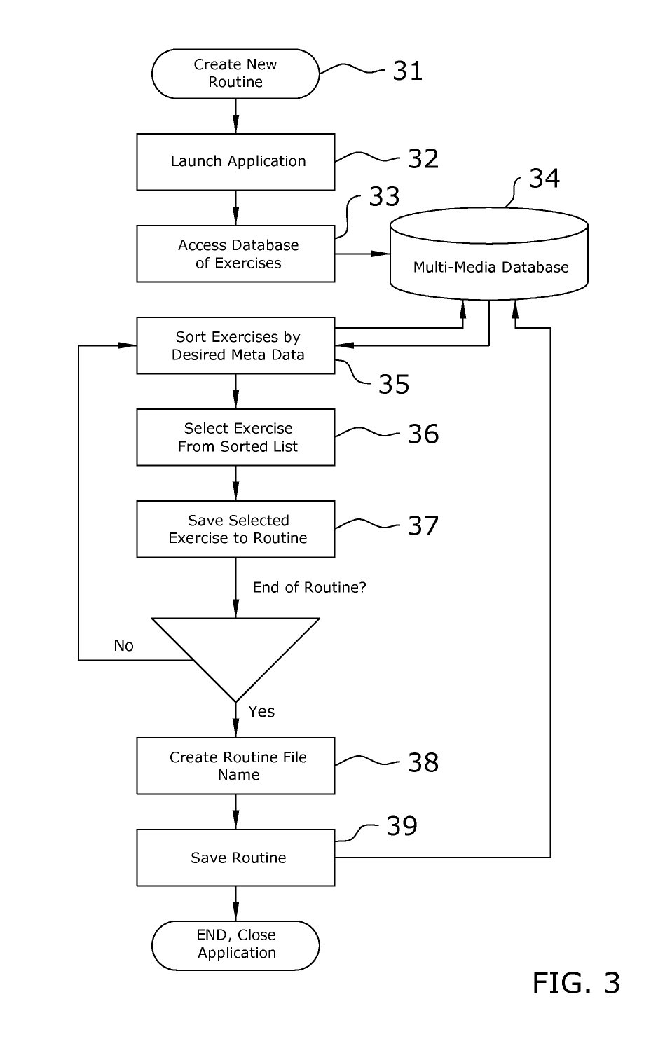

FIG. 3 depicts an embodiment of a flow chart of a method 30 of creating a multimedia exercise routine. More specifically, the flow chart of method 30 depicts the creation and running or playback of a multimedia exercise routine.

At 31, a Pilates instructor or exerciser begins to create a new exercise routine. For example, a user desires to create an exercise routine that focuses on a major muscle group.

At 32, software application 13 is launched. Software application 13, in one embodiment, is installed upon a computer or mobile device such as a smartphone or tablet.

At 33 and 34, the software application connects to a multimedia database, such as multimedia database 14 through a computer network, the multimedia database having been previously populated with one or more exercise files 15. Each such multimedia file corresponds to a specific Pilates exercise.

At 35, the Pilates instructor or exerciser, having accessed the database via the software application, views the multimedia files 15 using a sort, browse and/or search function in order to identify the desired exercise. The purpose of the selection process is to identify a desired exercise that will be one of a plurality of exercises comprising a complete workout routine.

At 36, upon identifying the desired exercise, the instructor or exerciser selects the desired exercise from a list of exercises. For example, the user selects the desired exercise from metadata table 60, as depicted in FIG. 5.

At 37, the exercise is saved for subsequent playback. The exercise, in one embodiment, is saved to database 14. After saving the desired exercise to a routine of exercises, the instructor or exerciser returns to the list of exercises (e.g., step 35), or creates a new list of exercises using the sort, browse or search function, and selects a second exercise using the same save function just described. The instructor or exerciser continues to select additional exercises until all of the desired exercises that will be performed during a routine of exercise has been selected.

At 38, upon finalizing all of the exercises in the routine, and thereby creating the routine of exercises, the instructor or exerciser prepares to save the routine for later playback by assigning a name to the routine.

At 39, via the software application 13, the routine is thereafter saved upon database 14 for later playback. Following saving the routine, the instructor or exerciser may then initiate playback, or as illustrated in the diagram, end the routine creation process and close the software application.

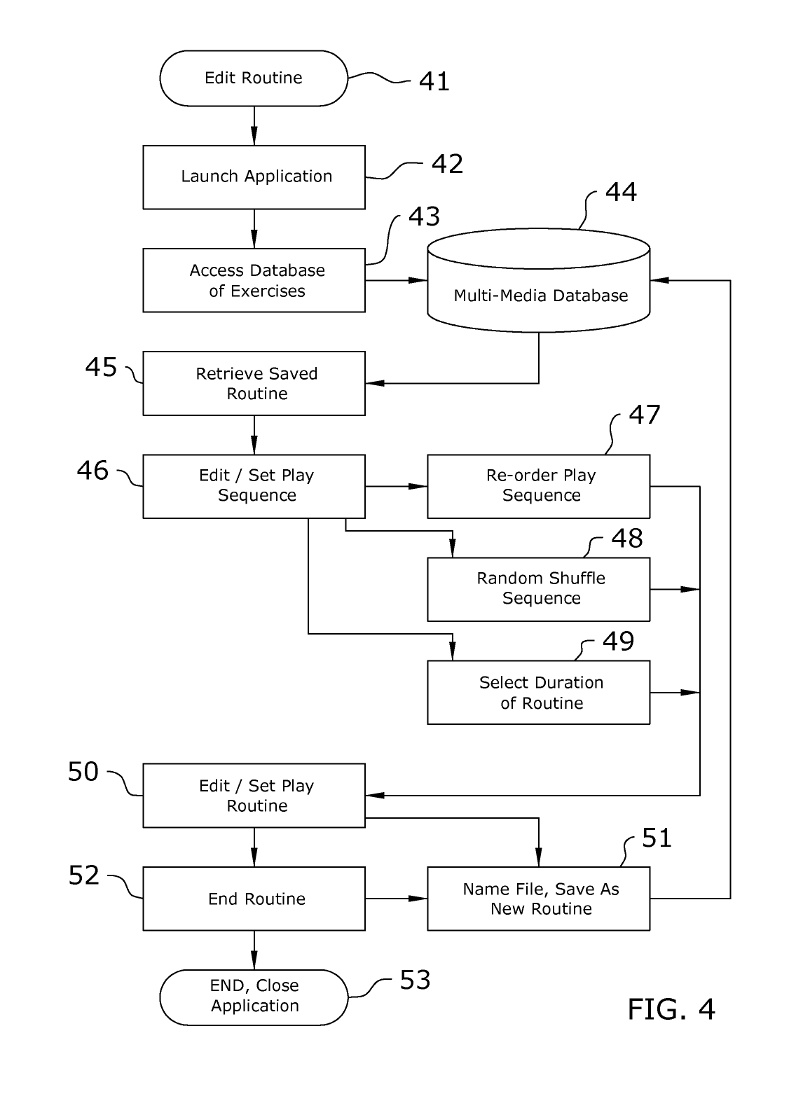

FIG. 4 depicts an embodiment of a flow chart of a method 40 of creating and/or editing a multimedia exercise routine. More specifically, the flow chart of method 40 depicts establishing a sequence by which the exercises will be displayed to the exerciser.

At 41 and 42, an authorized user of the video workout system desires to modify a previously saved routine. The user starts the process of editing the routine, by launching software application 13 that has been previously installed upon a device 10 which is connected to a network.

At 43 and 44, routine 16, stored in database 14, is accessed via software application 13. For example, a user provides user input, via device 10, such that application 13 accesses exercise files 15 (or routines) in database 14.

At 45, using a retrieval means, such as entering a routine name or number, browsing, searching, or clicking on a user list of routines, the user retrieves a desired routine (e.g., routine 16).

At 46, upon retrieving the desired routine, the user selects whether to play/run or edit/modify the routine. In the event the user wanted to run the routine without editing, and conduct a workout session, the user would simply select a play function following the selection of the desired routine, and begin the sequential routine of exercises upon a Pilates apparatus. The routine would then be digitally displayed in view of the exerciser upon a Pilates apparatus, thereby guiding the exerciser through each of the exercises in the workout routine.

At 47, if the user has elected to edit (or modify) the routine, optionally by changing the play sequence of the exercise files of the routine, the user may re-order existing exercises stored in the routine. Without detailing the many methods by which a user may modify the sequence of exercises in a routine, it should be understood that the user may move any exercise to play earlier or later within the play sequence.

Further, a user may desire the deletion or addition of an exercise to the existing routine. In other words, a user may desire to remove or add exercise media files to an existing multimedia exercise routine. A user may select a new exercise to add to the routine, and may do so using the routine creation process previously described. After selecting and adding a new exercise to the routine, the user may then move the exercise to play at any point in the play sequence by re-ordering the play sequence.

At 48, in some instances, it may be desirable to allow the plurality of exercises in a sequence to play in a random order (or in a random shuffle mode). For example, as a means to present and play back a specified collection of exercises in a routine in a different and unpredictable order to prevent monotony or break muscle memory that would otherwise occur if an exerciser repeated the identical sequence of exercises day after day. In order to actuate the random play function, the user would select the random shuffle sequence, then subsequently play the routine.

At 49, in one embodiment, a user may select a duration for the routine. For example, a user selects various exercise files, each with a known duration, such that the routine, as a whole, is created with a known duration (e.g., 50 minutes).

At 50, the user may either re-edit the routine, or set the routine to play (except for randomly shuffling the play sequence).

At 51, at such time the user is satisfied with the edit, the user may save the routine, or save-as a new file by selecting the appropriate save or save-as option, and saving the file to the database.

At 52, if the routine is instantly played, the duration of the routine will be the sum of the time duration of all of the exercises in the routine. The routine will play until completed, and then would end. If the user elects to save the routine after playing, they may save the routine, or save-as a new file by selecting the appropriate save or save-as option (step 51), and saving the file to the database.

At 53, if no more edits, and no more play is desired, the user may end the edit or play function by closing the application.

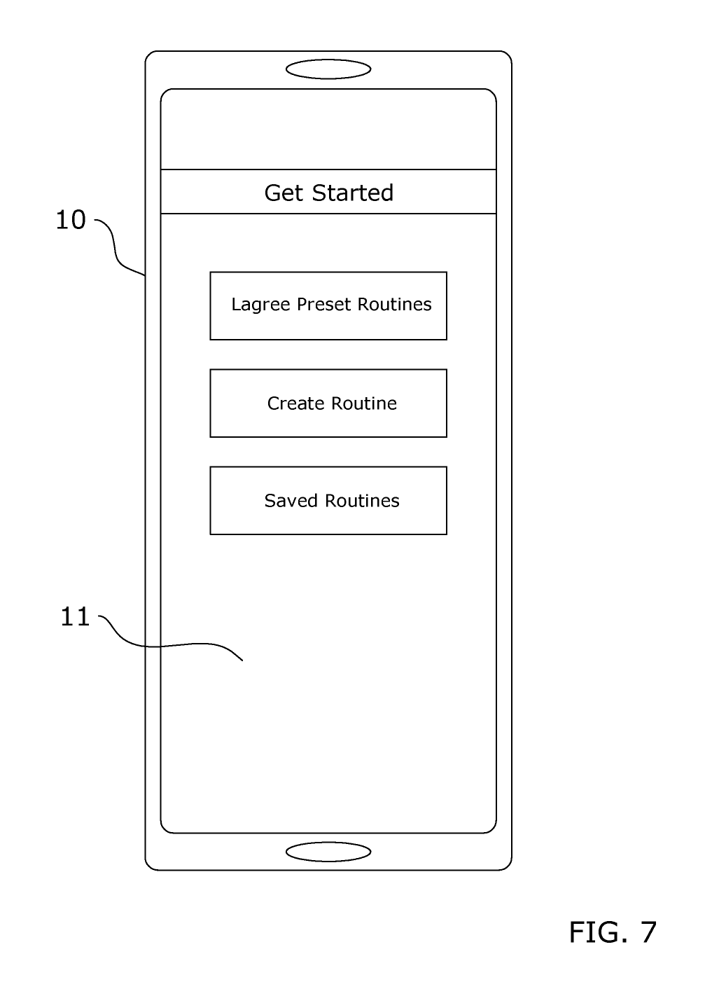

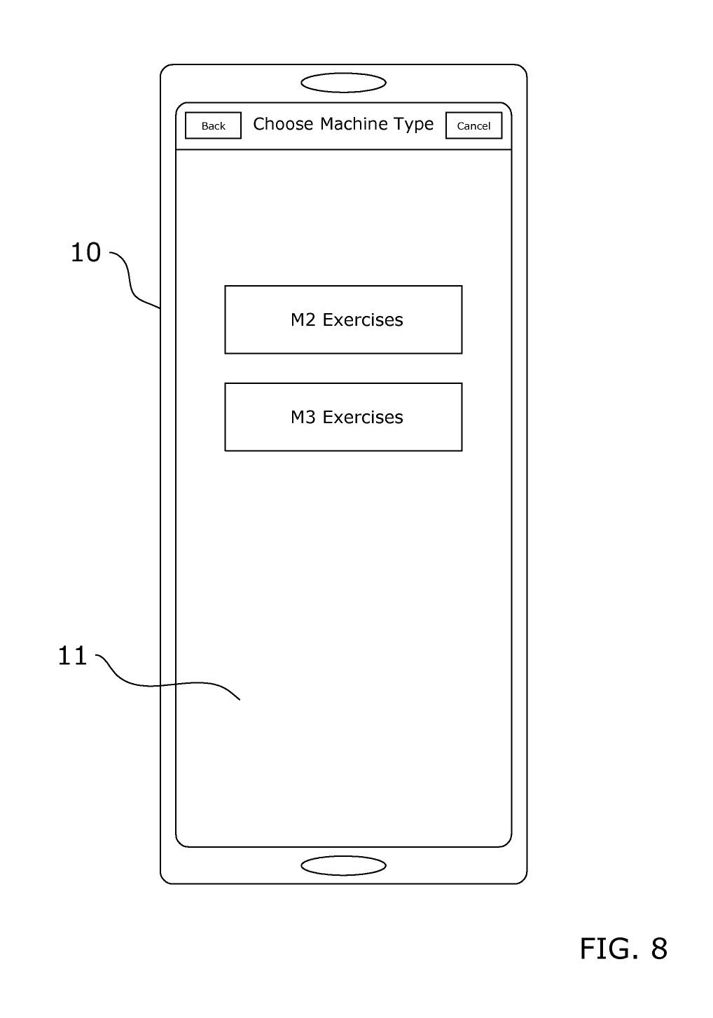

FIGS. 7 through 24 provide an exemplary illustration of the application displayed on the display 11 of a computer 10 such as a mobile device. FIG. 7 is an exemplary interface and home page for the application on a mobile device providing the user with options to select from to start an exercise routine. For example, the user can select from “Preset Routines” which have been preprogrammed into the system, the user can “Create Routine” to create a customized workout routine for the user or a class of students, or the user can access a “Saved Routine” to access previously created customized workout routines that have been saved in the system. The user selects the corresponding button on the home page displayed in FIG. 7.

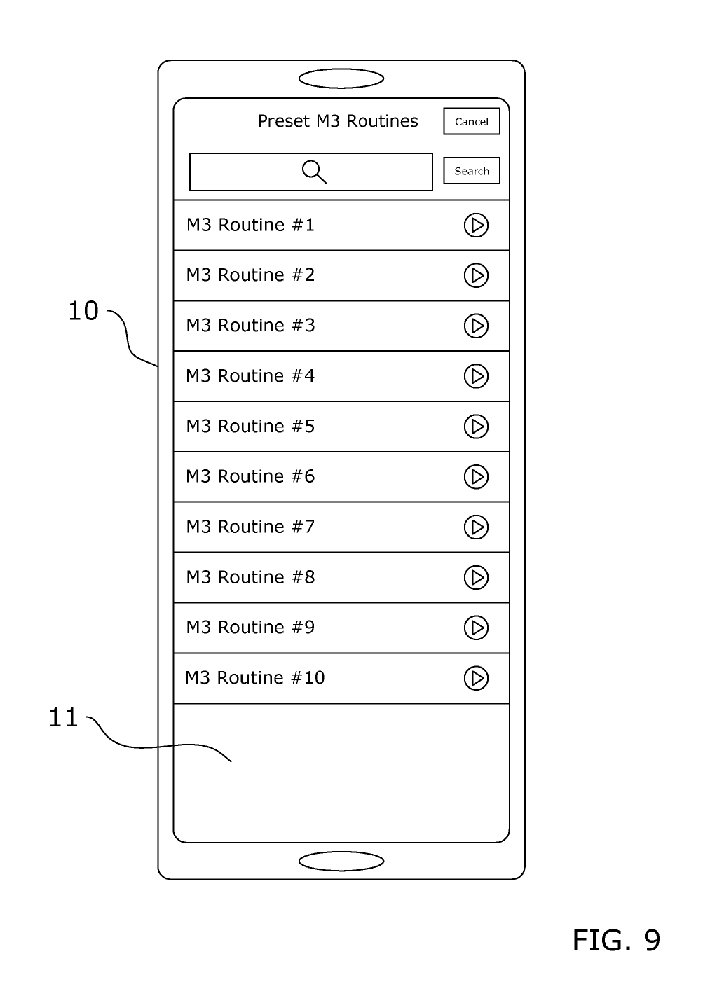

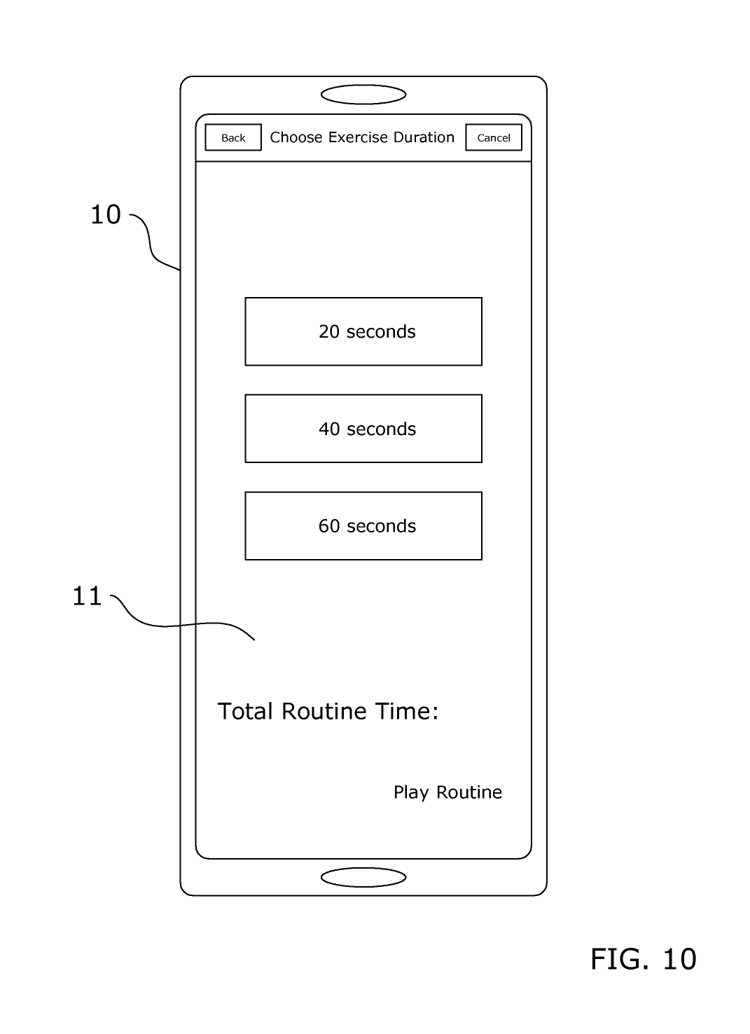

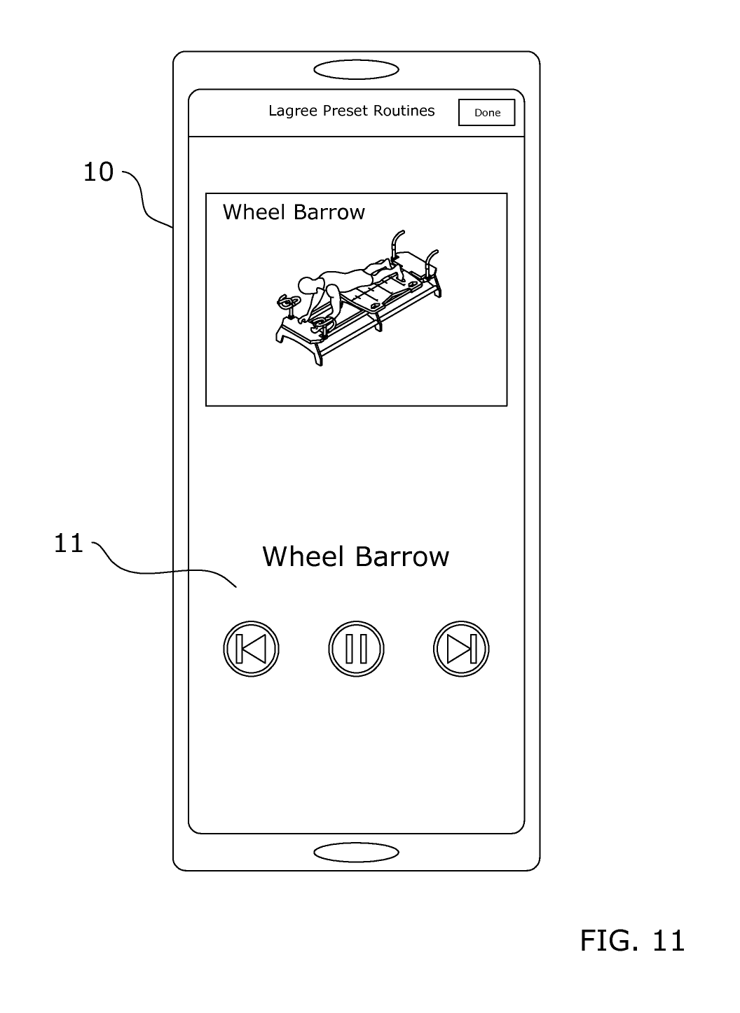

FIG. 8 is an exemplary interface displayed after selecting the “Preset Routines” button from FIG. 7 to present different exercise machine options to the user to select from. FIG. 9 is an exemplary interface displaying the various Preset Routines the user may select from and play based on the machine selection in FIG. 8. FIG. 10 is an exemplary interface providing time duration options for the user to select from so the user controls the length of time for each exercise performed in the routine. FIG. 11 is an exemplary interface illustrating the display of the wheel barrow exercise as part of a Preset Routine which the user can control by pausing, reversing or fast forwarding the exercise animation of an individual on the exercise machine performing the exercise. The wheel barrow exercise is displayed via a video display either by a graphic animation of a simulated person on a simulated machine or actual video of an actual user using the selected actual exercise machine and performing the selected exercise routine.

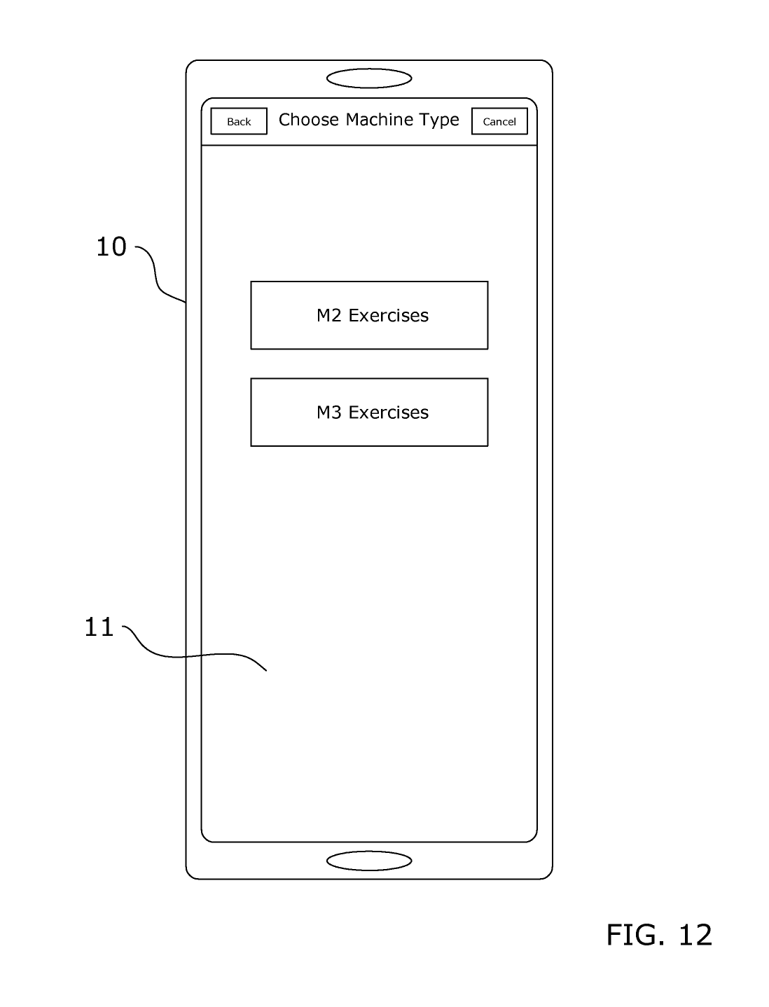

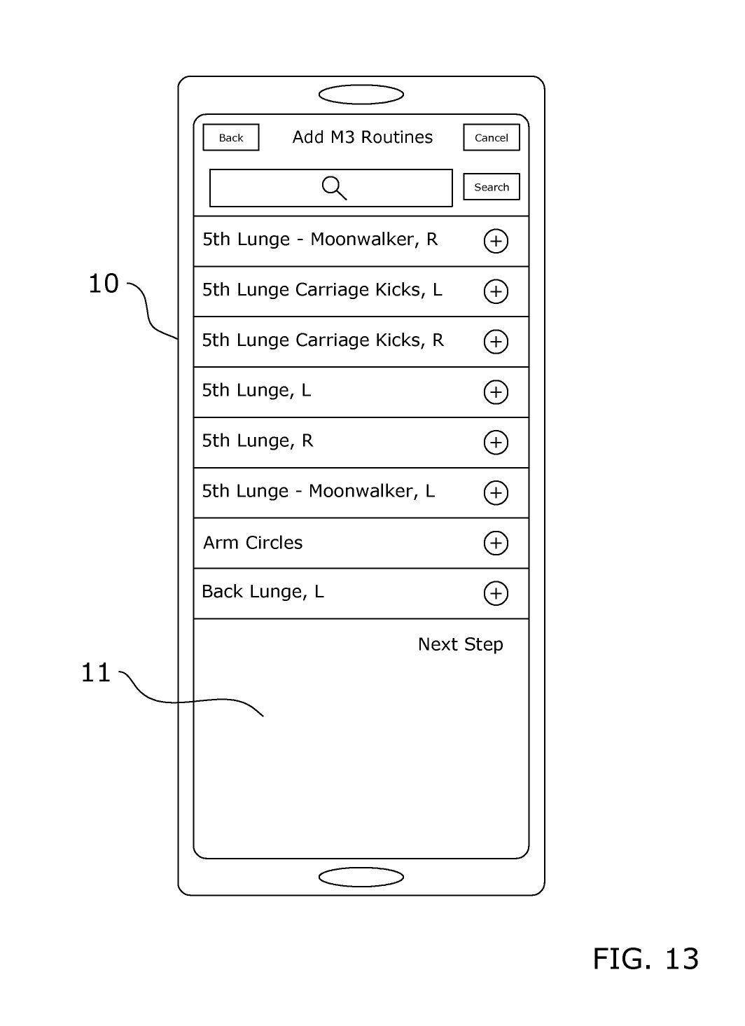

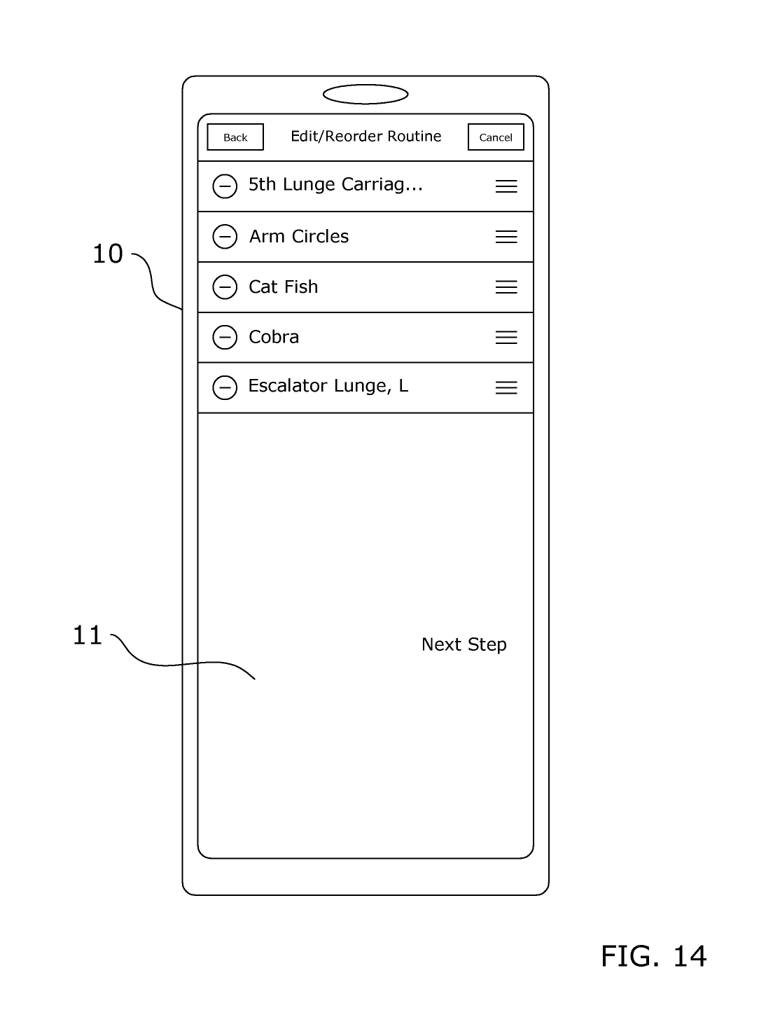

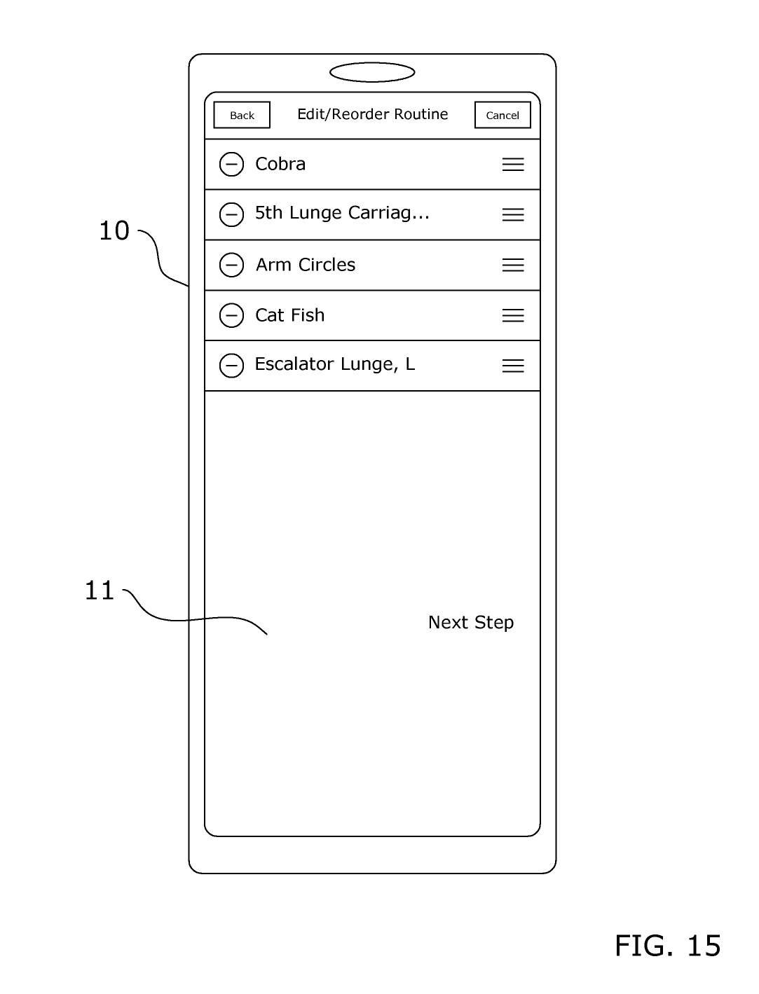

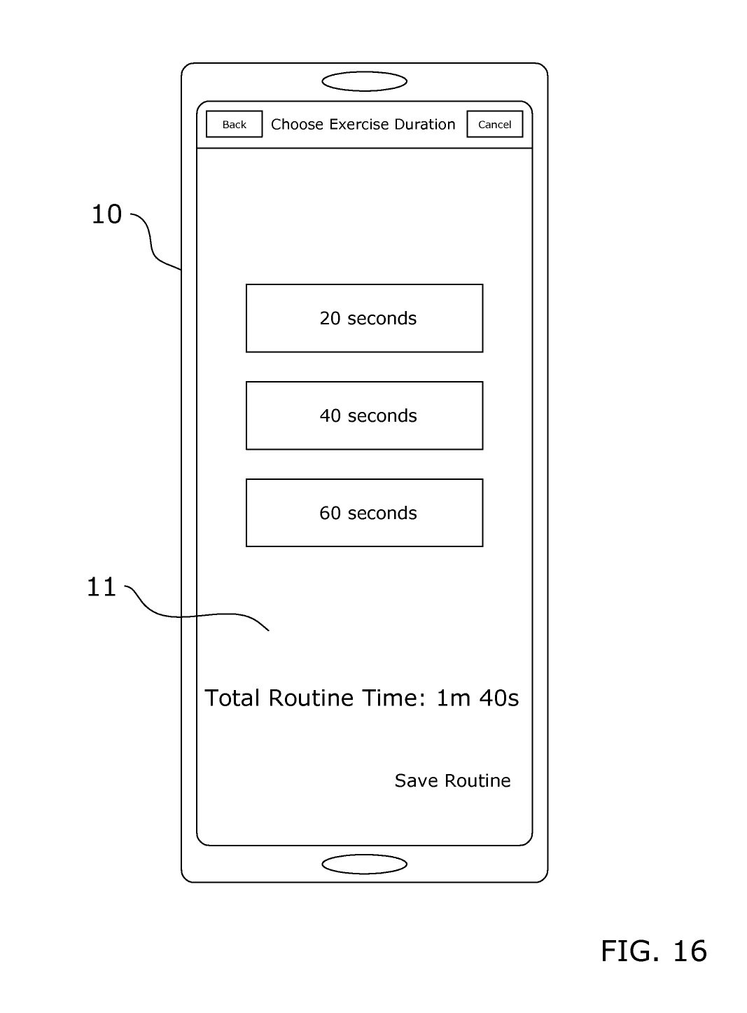

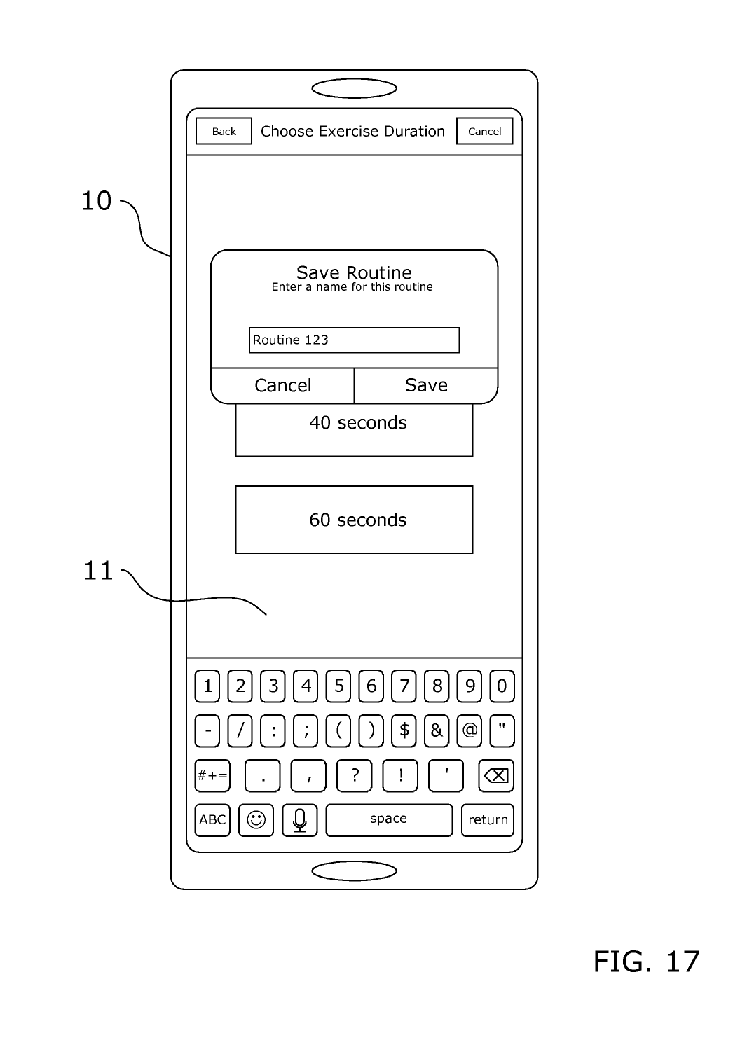

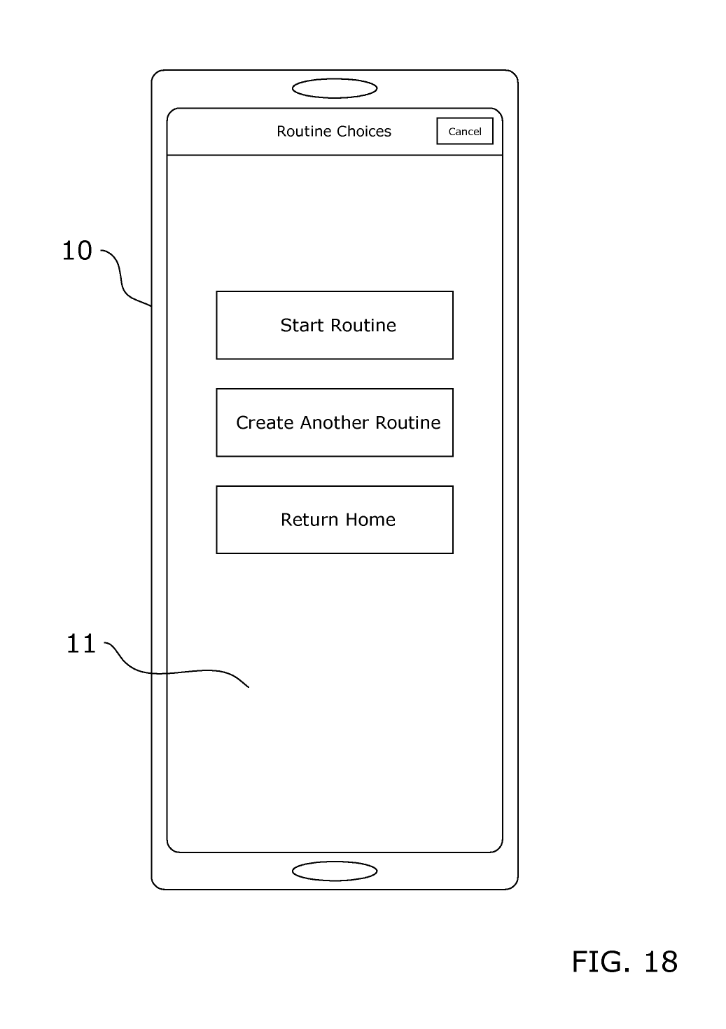

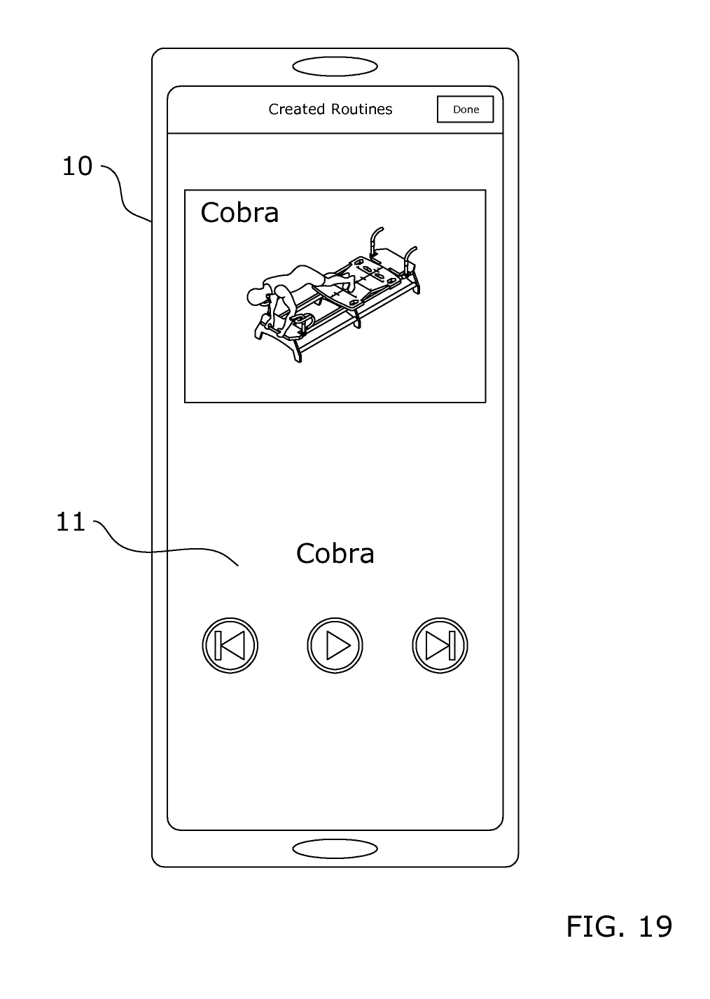

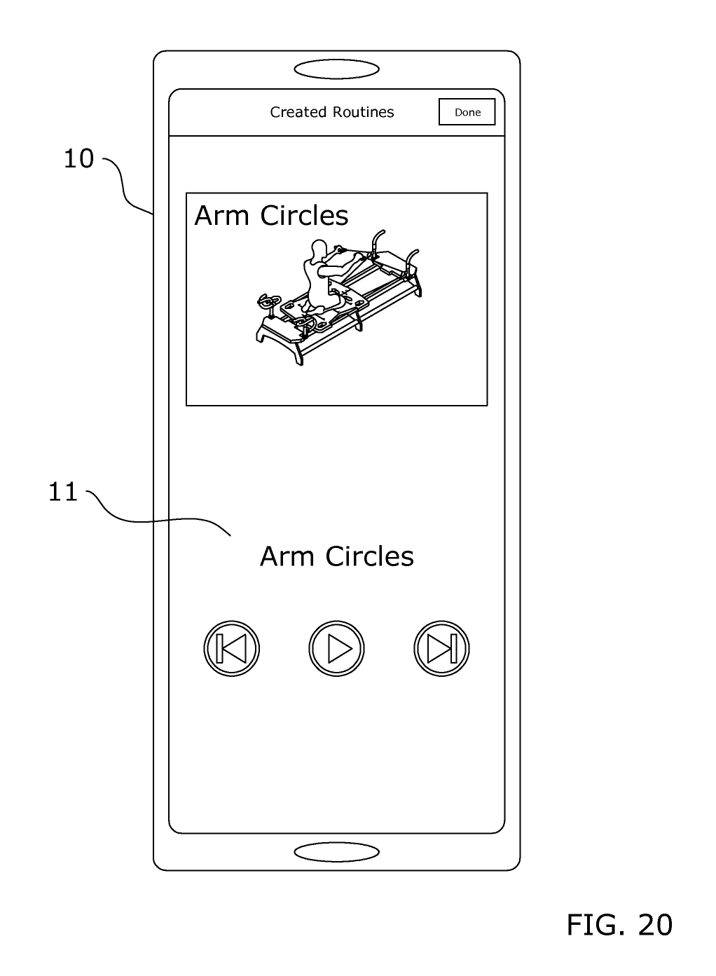

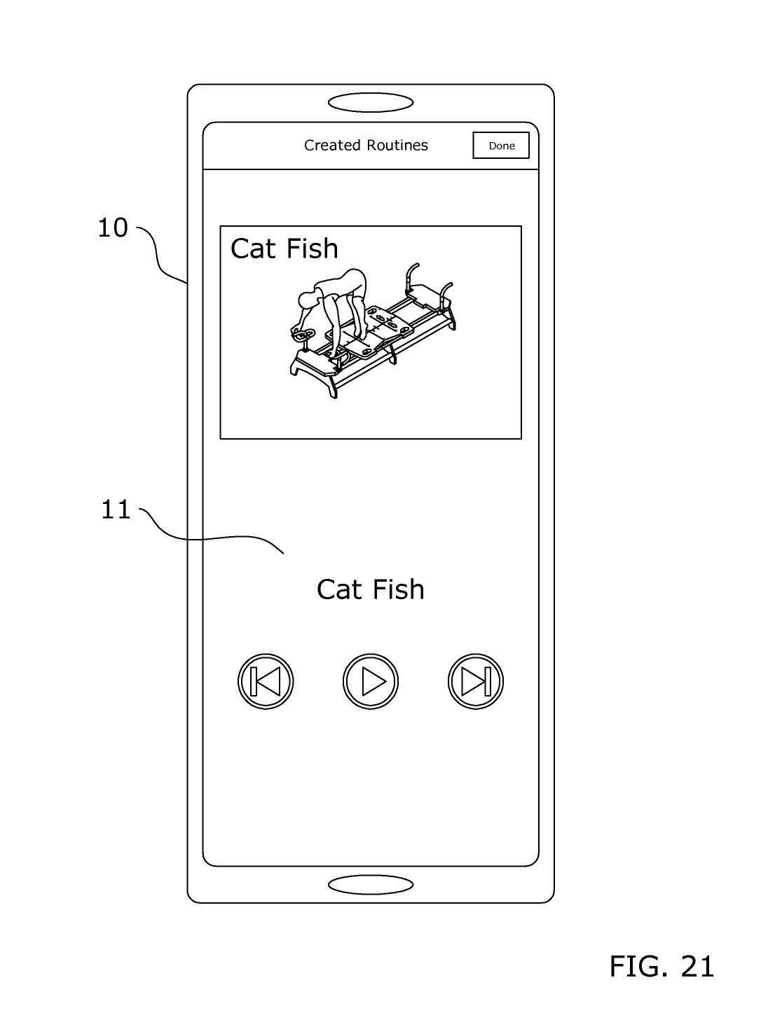

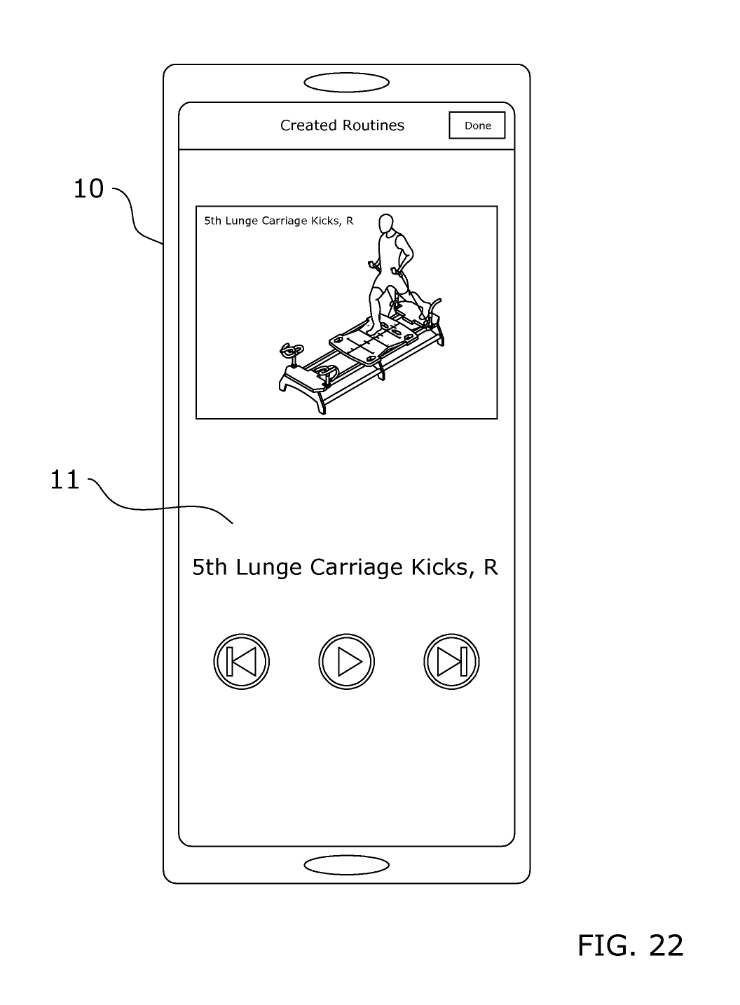

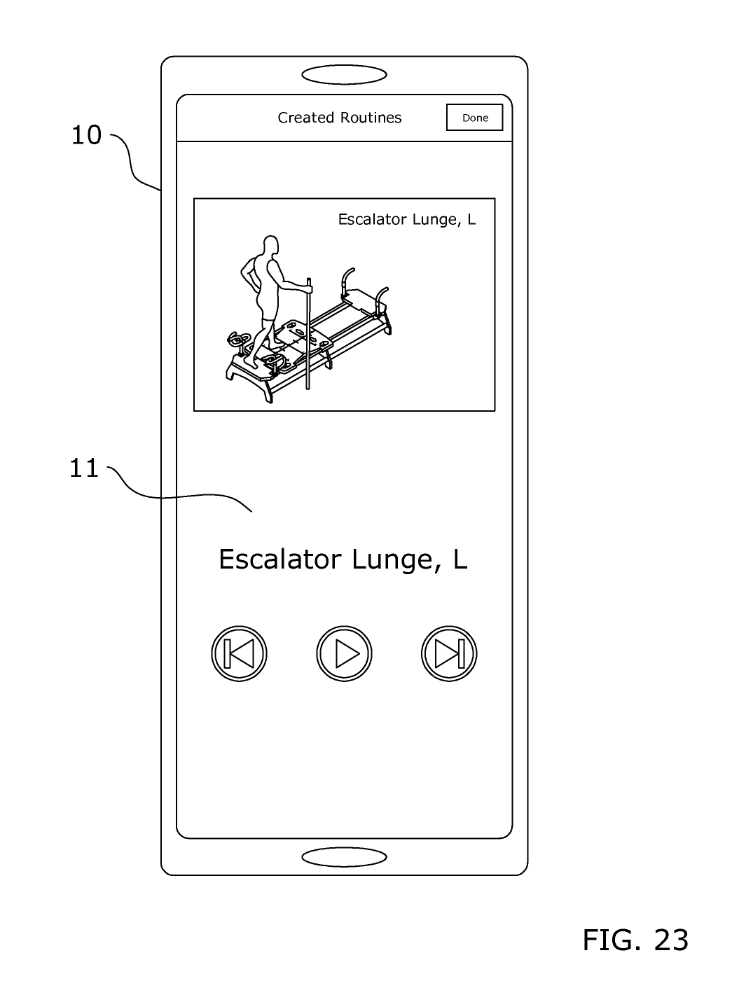

FIG. 12 is an exemplary interface displayed on the mobile device when a “Create Routine” option is selected from FIG. 7 displaying the machines the user is able to create an exercise routine for. Because every machine has different exercises available, it is important to provide the user with this option when creating a new routine. FIG. 13 is an exemplary display of the various routines for the selected exercise machine from FIG. 12 that the user can add to their customized exercise routine. The user selects the desired routines and the software application adds the selected routine(s) to the customized workout routine. FIG. 14 is an exemplary display of the exercise routines selected for the customized workout routine where the user can remove a routine or move the position played with respect to the other routines. FIG. 15 is an exemplary display of the selected exercise routines in FIG. 14 with the Cobra routine moved to the top of the list to be played first in the customized workout routine. FIG. 16 is an exemplary display providing various time options for each of the exercise routines selected for the customized workout. FIG. 17 is an exemplary interface where the user enters a customized name for the custom workout routine to be saved and used later. FIG. 18 is an exemplary interface providing the user with the option to start the customized routine created, create another routine or return to the home page. FIG. 19 is an exemplary illustration of the first routine (Cobra) of the customized workout routine being played via a graphical animation or video of an actual person performing the Cobra workout. FIG. 20 is an exemplary illustration of the second routine (Arm Circles) of the customized workout routine being visually played for the user. FIG. 21 is an exemplary illustration of the third routine (Cat Fish) of the customized workout routine being visually played for the user. FIG. 22 is an exemplary illustration of the fourth routine (5^{th} Lunge Carriage Kicks, R) of the customized workout routine being visually played for the user. FIG. 23 is an exemplary illustration of the fifth and last routine (Escalator Lunge, L) of the customized workout routine being visually played for the user.

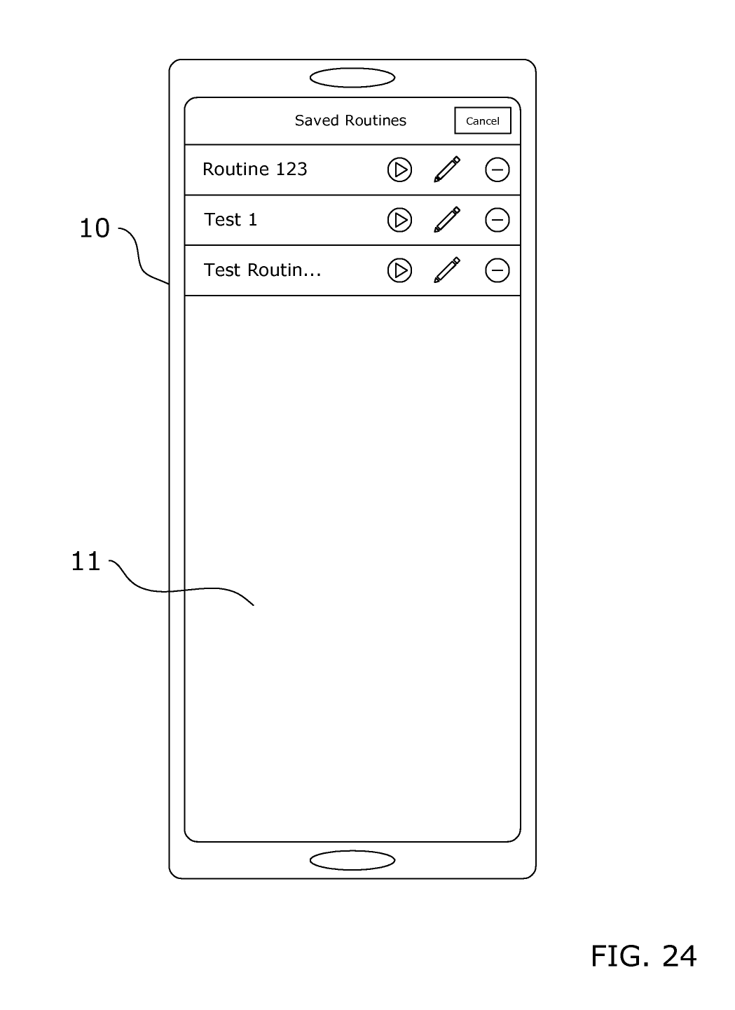

FIG. 24 is an exemplary interface providing the user with the list of saved routines when the “Saved Routines” button is selected from the home page in FIG. 7. The user is able to select one of the previously saved customized exercise routines for access at a later time.

It should be noted that ending or closing the software application may require log off by the user using any number of methods well known by those skilled in the art. The many methods of ending or closing out of a software application which are not mentioned or referenced are well known to those skilled in the art, and are simply security and user management functions that may be modified or eliminated without vitiating the novel function of the video system and method of the present invention.

It should be further noted that when a routine is played for exercisers as a Pilates exercise routine, the multimedia files may be played back digitally to or through a client display, such display may include video, audio, or both video and audio, and project as 2-D or 3-D on a display screen such as one or more computer monitors, a mobile device, television, or projected onto a light reflective surface by use of a video projector. The description of client devices used to display and play back the multimedia files is not meant to be limiting, and may include any client on a network of the present video workout system and method which would adequately serve as an instructional presentation to an exerciser throughout the duration of a Pilates exercise routine.

It should be noted that for clarity and efficiency, other functions of the software application such as creating a user profile, user passwords, logging in, managing a user account, managing one or more saved routines, deleting or editing saved routines, and other functionality typically associated with multi-user access to a database upon a network have not been shown. These functions, and other functions not mentioned or referenced are well known to those skilled in the art, and are simply security and user management functions that may be modified or eliminated without vitiating the novel function of the video system and method of the present invention.

### I. Embodiment of a Table of Exercise Files

FIG. 5 is an embodiment of table 60 representing a list of individually identifiable Pilates exercises in a database, and metadata fields that may be attached to each exercise contained in the database.

Those skilled in the art will appreciate that the selection of exercises to be performed by an exerciser during a workout session are not arbitrary. They are selected to specifically target certain muscles or groups of muscles that are to be exercised during the session. Further, they will appreciate that some exercises are very low intensity, and correspondingly burn fewer calories than higher intensity exercises. Therefore, it is important for a selection of exercises that may be performed singularly, or in a sequence with other Pilates exercises, offer to the instructor or exerciser a broad selection of exercises based on what muscles or muscle groups each exercise targets, the level of workout intensity that an exerciser must exert in order to accomplish each exercise, the length of time that an exercise should be performed, and other factors that would be referenced when selecting exercises for a workout routine on a Pilates apparatus.

As can be seen in the table 60, which is representative of a small section of a table of a multimedia database, exercise files, identified in the illustration as numbers one through four, are comprised of various data fields that include important considerations when selecting certain exercises to perform.

For example, exercise (or exercise file) number 1 is named the “Torso Extension”, and targets the muscles of the abdominal core of the exerciser. That is, the lower, upper, and oblique abdominal muscles will be fully engaged when this exercise is properly performed by the exerciser. Therefore, it is important for the instructor or exerciser to understand that this exercise will not be primarily working the muscles of the legs or shoulders to prevent the instructor or exerciser from including this exercise into a routine that is intended only to exercise the abdominal muscles.

Each of the data fields represent metadata that would be attached to each video, audio, or multimedia file that is prepared for each exercise in the database, such metadata providing extensive information related to each exercise. Although not all data fields are shown on the brief diagram, the list of metadata fields useful to an instructor or exerciser when selecting exercises to perform on a Pilates apparatus may include, but would not be limited to:
1) Exercise name;
2) Exercise identification number (ID);
3) File is only video;
4) File is only audio;
5) File is video plus audio;
6) Primary muscle targeted;
7) Muscle group targeted;
8) Recommended duration of the exercise;
9) Relative intensity of the exercise;
10) Pilates apparatus setup instructions;
11) Recommended spring resistance;
12) Incline or decline of the Pilates apparatus;
13) Routines that the exercise has been included into;
14) Exerciser position on the Pilates apparatus;
15) Safety tips or precautions;
16) Instructor's notes or comments;
17) Type of exercise machine the exercise routine is designed for.

Exercises may be selected in a number of ways, the following examples of which are not meant to be limiting, include: performing a text search on the multimedia database for keywords such as may be included in the instructor's notes data field; by sorting the list of exercises by any data field, such as targeted muscle group, or intensity; by a voice request through a voice recognition program that calls the corresponding exercise or list of exercises; by simply browsing through the list of exercises; or based on the time duration that the exercises are to be performed.

Those skilled in the art will appreciate the time-saving value, and the efficiency and precision of identifying the ideal exercises for any given workout routine to be performed on a Pilates apparatus as demonstrated by the new and novel video workout system.

Following the selection of an exercise using the method just described, the instructor or exerciser may then opt to play the exercise, thereby causing the video, audio or video and audio file to be presented on a video display, or projected by audio speakers and/or video projector in such a manner so as the exerciser may see and hear the instructional file while performing the selected exercise.

Further, after selecting an exercise using the method just described, the instructor or exerciser may save the exercise into a routine of two or more exercises such that when the routine is played back during a workout session, the selected exercises will play back in a sequence as determined by the exerciser or instructor beforehand.

### J. Embodiment of a Chart of an Exercise Routine

FIG. 6 is an embodiment of chart 70 of a Pilates exercise routine (e.g., routine 16) comprised of a sequence of two or more exercises (e.g., exercise files 15). In chart 70, a list of five exercises is shown. Referring to FIG. 5, it can readily be seen that the selected exercises are a subset of all of the individual Pilates exercises contained in a multimedia database.

Referring now to FIG. 6, various information is shown, including a top line that identifies the pre-selected list of exercises as a routine, namely, “Routine # R6”, although any unique identifier for each routine may be used.

Further, the exercises are arranged in a particular sequence in which they are to be performed. For instance, R6-001 is listed as the first exercise to be performed in the routine named as “R6”. There is no practical limit to the number of unique routines that may be created and stored upon the Pilates multimedia workout database.

As described herein, application 13 provides the ability of an instructor or exerciser to edit a routine. As a result, application 13 enables for the increasing or decreasing the total length of the routine, aided by the time references of each exercise. More specifically, the duration of the multimedia exercise routine may be modified by deleting of adding one or more exercises, or by rearranging the sequence that a list of exercises will be played over the duration of the routine. Additionally, any routine may be saved upon the multimedia database, and played at any future time when retrieved during a workout session.

In various embodiments, an instructor may stop and re-start an exercise routine after the initial playing of the routine. For example, if when the instructor notices an incorrect position of an exerciser and desires to momentarily stop the routine playback while the exerciser adjusts to the correct position. Therefore, an instructor or exerciser may also start or stop any individual exercise on demand, in real time, by retrieving an exercise from the multimedia database and causing it to be played so that it can be viewed and/or heard by the exerciser.

Accordingly, as described herein are various embodiments of a system and method of creating Pilates exercise multimedia files. In particular, storing exercise multimedia files upon a multimedia database accessible through a network, assembling one or more exercises into a routine of exercises, editing, stopping, and re-starting a routine, and displaying the instructional multimedia files upon appropriate video display and audio devices. Therefore, embodiments of the present invention overcome the longstanding problems associated with the costly time wasted by a Pilates instructor instructing exercisers in a Pilates studio, the complexity of assembling the correct exercises into a routine with a specific objective of isolating and exercising only certain muscle groups, and the problem of presenting the exerciser with persistent visual and audible instruction that guides the exerciser through proper positioning and performance of each Pilates exercise upon a Pilates apparatus.

Any and all headings are for convenience only and have no limiting effect. Unless otherwise defined, all technical and scientific terms used herein have the same meaning as commonly understood by one of ordinary skill in the art to which this invention belongs. Although specific terms are employed herein, they are used in a generic and descriptive sense only and not for purposes of limitation. All publications, patent applications, patents, and other references mentioned herein are incorporated by reference in their entirety to the extent allowed by applicable law and regulations.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs), DVDs (digital video discs), and computer instruction signals embodied in a transmission medium (with or without a carrier wave upon which the signals are modulated). For example, the transmission medium may include a telecommunications network, such as the Internet.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention. These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

The present invention may be embodied in other specific forms without departing from the spirit or essential attributes thereof, and it is therefore desired that the present embodiment be considered in all respects as illustrative and not restrictive. Many modifications and other embodiments of the invention will come to mind to one skilled in the art to which this invention pertains and having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although methods and materials similar to or equivalent to those described herein can be used in the practice or testing of the present invention, suitable methods and materials are described above. Thus, the present invention is not intended to be limited to the embodiments shown, but is to be accorded the widest scope consistent with the principles and features disclosed herein.

The invention claimed is:

1. A computer-implemented method for creating a multimedia exercise routine, said computer-implemented method comprising:
accessing a plurality of exercise multimedia files, wherein each of said plurality of exercise multimedia files comprise metadata;
sorting said plurality of exercise multimedia files based on said metadata;
selecting a sequence of said plurality of said exercise multimedia files; and
creating a multimedia exercise routine comprising said sequence of said plurality of said exercise multimedia files.

2. The computer-implemented method of claim 1, further comprising:
saving said multimedia exercise routine.

3. The computer-implemented method of claim 1, further comprising:
displaying said multimedia exercise routine.

4. The computer-implemented method of claim 1, further comprising:
modifying said sequence of said plurality of said exercise multimedia files.

5. The computer-implemented method of claim 1, further comprising:
modifying, in real-time, said sequence of said plurality of said exercise multimedia files.

6. The computer-implemented method of claim 1, further comprising:
re-ordering said sequence of said plurality of said exercise multimedia files.

7. The computer-implemented method of claim 1, further comprising:
selecting additional exercise multimedia files to said sequence of said plurality of said exercise multimedia files.

8. The computer-implemented method of claim 1, wherein said plurality of exercise multimedia files comprise:
a plurality of Pilates exercise multimedia files.

9. The computer-implemented method of claim 1, wherein said metadata is selected from a group consisting of:
length of time, associated primary muscle groups, number of repetitions, relative intensity, recommended resistance of a Pilates apparatus, and recommended body position upon said Pilates apparatus.

10. A computer-implemented method for creating a Pilates multimedia exercise routine, said computer-implemented method comprising:
accessing a plurality of Pilates exercise multimedia files from a database, wherein each of said plurality of Pilates exercise multimedia files comprise metadata;
sorting said plurality of Pilates exercise multimedia files based on said metadata;
selecting a sequence of said plurality of said Pilates exercise multimedia files; and
creating a Pilates multimedia exercise routine comprising said sequence of said plurality of said Pilates exercise multimedia files.

11. The computer-implemented method of claim 10, further comprising:
playing said Pilates multimedia exercise routine.

12. The computer-implemented method of claim 10, further comprising:
modifying said sequence of said plurality of said Pilates exercise multimedia files subsequent saving of said Pilates multimedia exercise routine.

13. The computer-implemented method of claim 10, further comprising:
modifying said sequence of said plurality of said Pilates exercise multimedia files during playing of said Pilates multimedia exercise routine.

14. The computer-implemented method of claim 10, further comprising:
re-ordering said sequence of said plurality of said Pilates exercise multimedia files during playing of said Pilates multimedia exercise routine.

15. The computer-implemented method of claim 10, further comprising:
selecting additional Pilates exercise multimedia files to said sequence of said plurality of said Pilates exercise multimedia files during playing of said Pilates multimedia exercise routine.

16. The computer-implemented method of claim 10, further comprising:
providing random shuffling of said sequence of said plurality of said Pilates exercise multimedia files during playing of said Pilates multimedia exercise routine.

17. The computer-implemented method of claim 10, further comprising:
removing at least one of said plurality of said Pilates exercise multimedia files during playing of said Pilates multimedia exercise routine.

18. The computer-implemented method of claim 10, further comprising:
saving said Pilates multimedia exercise routine to said database.

19. The computer-implemented method of claim 10, further comprising:
selecting a duration of said Pilates multimedia exercise routine.

20. The computer-implemented method of claim 10, wherein said metadata is selected from a group consisting of:
length of time, associated primary muscle groups, number of repetitions, relative intensity, recommended resistance of a Pilates apparatus, and recommended body position upon said Pilates apparatus.
